(19) United States
(12) Patent Application Publication
(10) Pub. No.: US 2007/0212471 A1
(43) Pub. Date: Sep. 13, 2007

(54) PREPARATION AND PRESERVATION METHOD OF A VEGETABLE-BASED FOOD PRODUCT CAPABLE OF BEING FRIED AT A LATER STAGE

(75) Inventors: Luc Fontaine, Renescure (FR); Carine Guemene, Renescure (FR)

Correspondence Address: EGBERT LAW OFFICES, 412 MAIN STREET, 7TH FLOOR, HOUSTON, TX, 77002, US

(73) Assignee: BONDUELLE, Societe Anonyme, Renescure (FR)

(21) Appl. No.: 11/680,513

(22) Filed: Feb. 28, 2007

(30) Foreign Application Priority Data
Mar. 7, 2006 (FR) 06/02021

(51) Int. Cl. A23L 1/212

(52) U.S. Cl. 426/615

(57) ABSTRACT

The invention relates to a preparation and preservation method of a vegetable-based food product, capable of being fried at a later stage, prior to the consumption thereof, such as a doughnut. The method includes: crushing one or several frozen vegetables; preparing pieces of one or several frozen vegetables; mixing the crushed vegetables with the pieces of vegetables; shaping the mixture at a given temperature; applying at least one crusty coating to the product; and deep-freezing the product after application of the crusty coating. A product, not fried and frozen, such as mashed vegetables enveloped with a frozen crusty coating is formed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a preparation and preservation method of a vegetable-based food product, capable of being fried at a later stage, such as a doughnut, and the product obtained. More particularly, the invention relates to a foodstuff including one or several vegetables, such as in particular carrots, corn and/or supersweet corn.

2. Description of Related Art Including Information Disclosed Under 37 CFR 1.97 and 37 CFR 1.98

Currently, in the field of the frozen foodstuffs, products including a single type of vegetables at a time are generally known and are either in the form of a mash or in pieces. Mixtures of pieces of frozen vegetables are also known.

There are, moreover, foodstuffs including a mixture of mash and pieces of vegetables, as described in French patent document FR-2.847.427. According to this document, this type of products is pre-fried before deep-freezing, then sold directly to the consumers or to a restaurant owner who will re-heat them.

As a basic hypothesis, it has been noticed that preparation processes exhibited several shortcomings, in particular with regard to the preparation time of the product and its caloric value.

In particular, when the processes used today in the preparation of these foodstuffs comprise a cooking step by frying the product before deep-freezing, the product is been sold to a restaurant owner or to an individual. The consumer will re-heat the product with another frying as a second cooking step before eating. This process exhibits the shortcoming of increasing the oil absorption by the product and hence increasing calories.

Moreover, in the majority of the catering events, for the accompaniment of main courses, more or less sophisticated, fried potatoes involving double frying are used, regardless of whether the products are fresh or frozen. These products are generally praised by the consumer but constitute a handicap regarding their fat content.

The invention aims to remedy these shortcomings aforementioned while offering a new preparation and preservation method of a vegetable-based food product, capable of being fried at a later stage, such as a doughnut, through which the product consumed is fried a single time in oil.

Another aim of the present invention is to offer a product including the vegetables in the form of pieces or a mash, with a minimum of fats.

Another aim of the present invention is to offer a new process which is quicker and hence more efficient.

Another aim of the present invention is to offer a foodstuff whereof the taste and playful aspects are appreciated by the consumer, exhibiting a crusty envelope and a vegetable-based soft center.

Other aims and advantages of the present invention will appear from the following description, given solely by way of example and without being limited thereto.

### BRIEF SUMMARY OF THE INVENTION

The invention relates to a preparation and preservation method of a vegetable-based food product, capable of being fried at a later stage, prior to the consumption thereof, such as a doughnut, wherein the following successive steps are carried out:
one or several frozen vegetables are crushed,
pieces of one or several frozen vegetables are prepared,
said crushed vegetables are mixed with said pieces of vegetables,
the mixture obtained during mixing in the third step aforementioned, is shaped at a given temperature,
at least one crusty coating of the product is performed after the shaping thereof, and
the product is deep-frozen after application of the crusty coating, so as to obtain a product, not fried and frozen, such as mashed vegetables enveloped with a frozen crusty coating. The invention relates moreover to a method for manufacturing a foodstuff wherein the frozen foodstuff is fried once in oil at given temperature and for a given time so as to provide a fried product, such as a doughnut.

The invention relates finally to a foodstuff obtained by the implementation of the processes as aforementioned.

### DETAILED DESCRIPTION OF THE INVENTION

The invention will be understood better when reading the following description.

The invention relates to a preparation and preservation method of a vegetable-based food product, capable of being fried at a later stage, prior to the consumption thereof, such as a doughnut.

According to the process of the invention, the following successive steps are carried out.

In a first step, one or several frozen vegetables are crushed.

According to the present invention, the vegetables, crushed during the first step of the process, are at a temperature close to at least −18° C. before crushing. In this first step, said vegetable mash obtained after crushing has, in particular, a temperature close to −2° C.

In a second step, pieces of one or several frozen vegetables are prepared. To do so, in particular, said pieces of vegetables are obtained by cutting vegetables at a temperature close to at least −18° C.

After crushing, the temperature of the mash is close to −2° C., which enables adding pieces of one or several frozen vegetables to the frozen vegetables crushed previously.

In a third step, said vegetables crushed during said first step are mixed with said pieces of vegetables of said second step, so as to provide a product formed of a mixture of vegetables in the form of a mash and pieces.

In a fourth step, the mixture obtained during mixing in said third step is shaped at a given temperature. Such formation enables the product to obtain a requested shape, in particular, in the form of a ball.

By way of non-restrictive example, good results have been obtained with a product in the form of a ball with a diameter ranging between 2 and 4 cm and with a weight ranging between 12 and 15 g.

In a fifth step, at least one crusty coating of the product is performed after the shaping thereof.

This crusty coating enables the product to become more solid and more resistant to cooking. It forms a barrier for absorbing the fat, used during the subsequent frying.

One of the advantages of the process as described in the present application is to provide a percentage of fats of approximately 9%, vastly lower than the percentage between 20 and 30% observed today in the products on the market.

According to the present invention, the crusty coating is made from crushed cornflakes. Still, any other vegetable suitable as a coating may be used.

In the final step of the method, as described in the present invention, the product is deep-frozen after application of the crusty coating, so as to obtain a product, not fried and frozen, such as mashed vegetables enveloped with such a frozen crusty coating.

According to another embodiment of the present invention, an additional step is performed, consisting of mixing the product obtained with a set of excipients, aromas and/or taste-promoters, after mixing the crushed vegetables and the pieces of vegetables.

According to another embodiment of the present invention, an additional step is performed, consisting of coating by immersion or spraying, before said crusty coating, during which at least one other coating of said formatted product is conducted. Such coating, by way of a non-restrictive example, is performed by immersion or spraying.

The coating is conducted normally with a curtain-type coating machine with re-circulation and cooling cycles, but any other method obvious to the man of the art may be used.

Said coating is made from a frying dough including Kerry powder and water. By way of a non-restrictive example, said frying dough consists of 35% Kerry powder and 65% water.

Besides, and by way of a non-restrictive example, good results have been obtained with selected crushed vegetables, individually or in mixture, among corn, supersweet corn and/or carrots.

Similarly, the frozen vegetables are selected advantageously but not exclusively, individually or in mixture, among corn, supersweet corn and/or carrots.

Still, any other vegetable suitable to this type of foodstuff may be used.

Still according to the present invention, the set of excipients, aromas and/or taste-promoters includes, for instance, at least methocel A16M, salt, potato starch, potato fiber, and dextrose.

Once the frozen foodstuff has been obtained according to the method in the present invention, thanks in particular to said crusty coating, said frozen foodstuff, not fried previously, is fried. When the time comes for the consumption thereof, the product is fried only once, in particular in oil at given temperature and for a given time, so as to provide a fried product, such as a doughnut.

By way of a non-restrictive example, the frozen product is left in oil between 3 and 4 minutes.

The present invention also relates to protect the foodstuffs obtained by the implementation of processes as described above.

Obviously, other embodiments, understandable to the man of the art, could have been contemplated without departing from the framework of the invention as defined by the claims.

1. Preparation and preservation method of a vegetable-based food product, capable of being fried at a later stage, prior to the consumption thereof, such as a doughnut, the method comprising the steps of:
crushing at least one of a plurality of frozen vegetables;
preparing pieces of at one of a plurality of frozen vegetables;
mixing the crushed vegetables with said pieces of vegetables;
shaping the mixture at a given temperature;
applying at least one crusty coating after shaping the mixture into a product; and
deep-freezing the product.

2. A method according to claim 1, wherein the crushed vegetables are at a temperature close to at least −18° C. before crushing, said pieces of vegetables being obtained by cutting vegetables at a temperature close to at least −18° C.

3. A method according to claim 1, further comprising the step of:
mixing a set of excipients, of aromas and/or taste-promoters with the crushed vegetables and said pieces of vegetables.

4. A method according to claim 1, further comprising the step of:
applying at least one coating before applying said crusty coating.

5. A method according to claim 4, wherein said one coating is performed by immersion or spraying.

6. A method according to claim 4, wherein said one coating is comprised of a frying dough of Kerry powder and water.

7. A method according to claim 1, wherein said at least one crusty coating is comprised of crushed cornflakes.

8. A method according to claim 1, wherein the crushed vegetables are selected, individually or in mixture, among corn, supersweet corn and/or carrots.

9. A method according to claim 1, wherein said pieces of vegetables are selected, individually or in mixture, among corn, supersweet corn and/or carrots.

10. A method according to claim 3, wherein said set of excipients, aromas and/or taste-promoters is comprised of a group consisting of at least methocel A16M, salt, potato starch, potato fibre and dextrose.

11. A method for preparing foodstuff according to claim 1, further comprising:
frying the frozen product in oil at a given temperature and for a given time to provide a fried product.

12. A method according to claim 11, wherein the frozen product is left in oil between 3 and 4 minutes.

13. A foodstuff obtained by the implementation of the method according to claim 1.
